(19) United States
(12) Patent Application Publication
(10) Pub. No.: US 2015/0071274 A1
(43) Pub. Date: Mar. 12, 2015

(54) CABLE ASSEMBLY WITH INTEGRATED WIRELESS PROXIMITY SENSORS

(71) Applicant: Emanate Wireless, Inc., Ijamsville, MD (US)

(72) Inventors: Gary L. Sugar, San Francisco, CA (US); Chandra Vaidyanathan, Rockville, MD (US); Yohannes Tesfai, Silver Spring, MD (US)

(21) Appl. No.: 14/479,618

(22) Filed: Sep. 8, 2014

Related U.S. Application Data
(60) Provisional application No. 61/876,301, filed on Sep. 11, 2013.

(51) Int. Cl. H04W 4/02; H04W 64/00; H04W 4/00; H04W 84/12

(52) U.S. Cl. CPC H04W 4/02; H04W 84/12; H04W 64/00; H04W 4/008
USPC 370/338

(57) ABSTRACT

In one embodiment, a cable assembly is provided that comprises a cable, one or more radio transceivers spaced along the length of the cable; and a first set of one or more integrated conductors within the cable to supplying supply DC power and ground to the one or more radio transceivers.

### CROSS-REFERENCE TO RELATED APPLICATION

This application claims the benefit of U.S. Provisional Patent Application No. 61/876,301 filed Sep. 11, 2013, the entirety of which is incorporated herein by reference.

### BACKGROUND

There is a strong market need for an indoor electronic positioning system that can provide one-meter accuracy or better. Mobile retail applications for smartphones are one of the biggest revenue drivers behind this need, allowing users to, among other things, determine what is currently on sale in the aisle of the store they are in, determine which items from their shopping list are sold in the aisle they are walking in, or simply to obtain information about a nearby product or display.

One indoor positioning technique that has become popular recently leverages the Bluetooth® Low Energy (BLE) wireless standard for indoor proximity detection. Apple, Inc. has published a standard for so-called “iBeacons”—low-powered, low-cost BLE transmitters that can notify nearby iOS® 7 devices of their presence. This technology enables a smart phone or other device to perform actions when in close proximity to an iBeacon. One application is to help smartphones determine their precise position. With the help of an iBeacon, a smartphone's software can pinpoint its own location in a store. The vision was for retail store management to place numerous small, coin-cell battery-powered iBeacon emitters in various positions throughout the store (e.g. every 6-10 feet along each aisle). Each iBeacon would periodically (typically once per second) broadcast a BLE advertisement message containing its universally unique identifier (UUID), and smartphones moving around the store could locate themselves by listening for the iBeacon transmissions and determining their position by looking up the UUID of the closest (i.e., producing the largest received signal strength) iBeacon in a database. A similar BLE-based proximity sensing technique has been introduced for Android® smartphone devices.

There are a number of challenges with Apple's original vision: (1) retail store owners do not like to replace batteries, (2) installing discrete iBeacons in a retail store leaves them prone to theft or damage, (3) there is no centralized way to configure or control the iBeacons, to update their firmware, to change their operating parameters (e.g., Tx beacon interval, Tx power, etc.) or to run health checks to ensure they're working properly, (4) the iBeacons all transmit at the same frequencies but are not time-synchronized, so some of their transmissions will interfere with one another.

Another challenge concerns battery life on the smartphone. Since the iBeacons run off of a small battery, they can send out BLE advertisements no more frequently than once per second without emptying their batteries too quickly. This means that the smartphone needs to keep its receiver powered on with a very high duty cycle (at least 50%) to hear a sufficient number of the iBeacon transmissions to ensure a reasonable location update rate (e.g., once per two seconds on average). This high of a receiver duty cycle will have a significant negative impact on the smartphone's battery life.

### BRIEF DESCRIPTION OF THE DRAWINGS

The skilled artisan will understand that the drawings, described below, are for illustration purposes only. The drawings are not intended to limit the scope of the present teachings in any way.

FIG. 1 shows a block diagram of cable assembly according to a first example embodiment.

FIG. 2 illustrates a physical appearance of the cable assembly of FIG. 1, according to an example embodiment.

FIG. 3 shows a block diagram of a cable assembly according to a second example embodiment, having a power conditioning module (PCM) and cable unit (CU) implemented as physically separate, connectorized components.

FIG. 4 illustrates a physical appearance of the cable assembly of FIG. 3, according to an example embodiment.

FIG. 5 shows a block diagram of a cable assembly that uses an AC outlet instead of 802.3af/at PoE for power and WiFi instead of Ethernet to communicate with a network, according to an example embodiment.

FIGS. 6 and 7 show how a plurality of cable assemblies can be used in a mobile retail application, according to an example embodiment.

FIG. 8 shows a ladder diagram of a message flow among a server, mobile device and cable assembly, according to an example embodiment.

FIG. 9 shows a block diagram for a cable assembly according to still another embodiment.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF EXAMPLE EMBODIMENTS

Various embodiments are presented herein for a cable assembly. The cable assembly integrates a DC power supply and a plurality of BLE radios such that one or more cable such assemblies can be arranged/positioned along the aisles of a retail store or in other similar environments. The BLE radios are powered from either an IEEE 802.3af/at-powered local area network (LAN) switch or from an AC outlet, so that there is no need to replace batteries of the cable assembly. This integrated cable approach makes it easy to hide the cable in or alongside the shelving units or other structures in deployment environment to avoid theft or damage. Each cable assembly has an integrated central processing unit (CPU) and a serial data bus to configure and control the BLE radios, and can communicate with other networking equipment such as a centralized web sever on a network via IEEE 802.3 wired Ethernet or a Wi-Fi® wireless local area network (WLAN). The serial data bus and network connectivity also allows the cable assemblies to time-synchronize their BLE transmissions in order to minimize interference. The centralized control capability also allows for centralized configuration and control, health checking and firmware updates for all deployed BLE radios. Finally, since battery life is not a concern for the cable assembly presented herein, the BLE radios can be configured to transmit BLE advertisements much more frequently than their battery powered counterparts, allowing the smartphones and user devices to scan less frequently and thus conserve battery life.

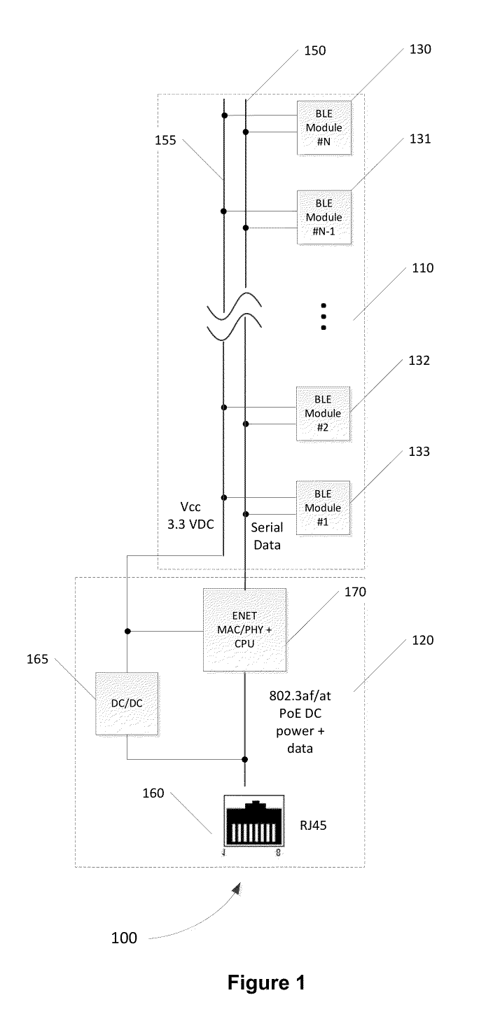

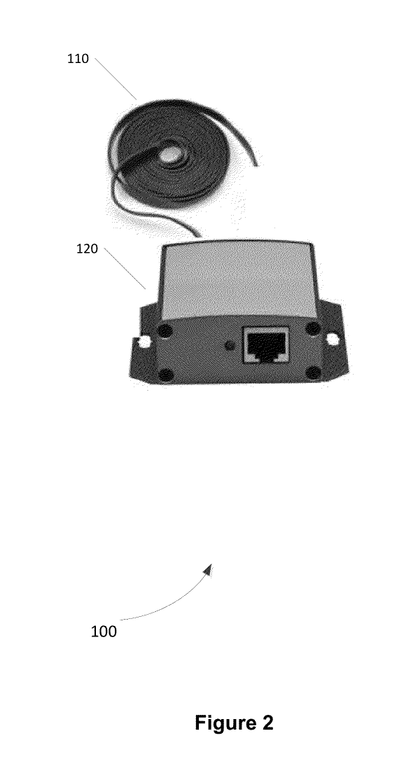

FIG. 1 shows a block diagram of cable assembly 100 according to one embodiment, and FIG. 2 shows an illustration of the cable assembly 100 in a commercial product, in one example. The cable assembly 100 has two main components: a power conditioning module (PCM) 120 and a cable unit (CU) 110. The PCM 120 has an RJ45 jack 160, a DC-to-DC converter 165 and an embedded microprocessor chip or chips 170 with an integrated Ethernet MAC/PHY (ENET/MAC/PHY+CPU). The RJ45 jack 160 connects the cable assembly to a CatS cable carrying Ethernet data and 12-20 Watts of DC power from the switch 620. The DC-to-DC converter 165 extracts DC power from the attached CatS cable and regulates it down to the voltage(s) that are required by the microprocessor 170 and the DC power lines 155 that are used to power BLE modules 130-133 in the CU 110.

The CU 110 may take the form of a long (up to 300 feet), flat cable containing one or more conductors 155 for DC power, one or more conductors 150 for ground and low-speed serial data that is passed between the microprocessor 170 and the BLE modules 130-133. Each BLE module is typically small but flat—typically 9×12×1 mm. Thus, the CU 110 may be flat instead of round—and may contains one or more system-of-chips (SoCs) to implement that BLE MAC, PHY and RF portions, a voltage regulator, an RF front-end, and a 2.4 GHz antenna. The one or more conductors 150 for serial data bus are used to carry messages and data between the microprocessor 170 and the BLE modules.

The antenna (not shown) associated with each BLE module can either be omnidirectional or directional. Using directional antennas that are aimed toward the center of each aisle could help the mobile user device determine on which aisle (i.e., which side of the cable assembly) the mobile user device is located.

One potential challenge with the design of the CU 110 is the voltage drop in Vcc in the conductor(s) 155 along the length of the cable. An effective way to mitigate this issue is to source a high DC voltage at the output of the DC/DC converter 165 so that it is just high enough to power the last BLE module 130 at the end of the longest planned CU. A fixed resistor can be used between the Vcc line 155 and the Vcc input to the BLE modules that are closer to the DC/DC converter 165 in order to limit the input voltage to the BLE modules. The closer the BLE module is to the DC/DC converter 165, the larger the required voltage drop and hence the larger the resistor value for the resistor to be used.

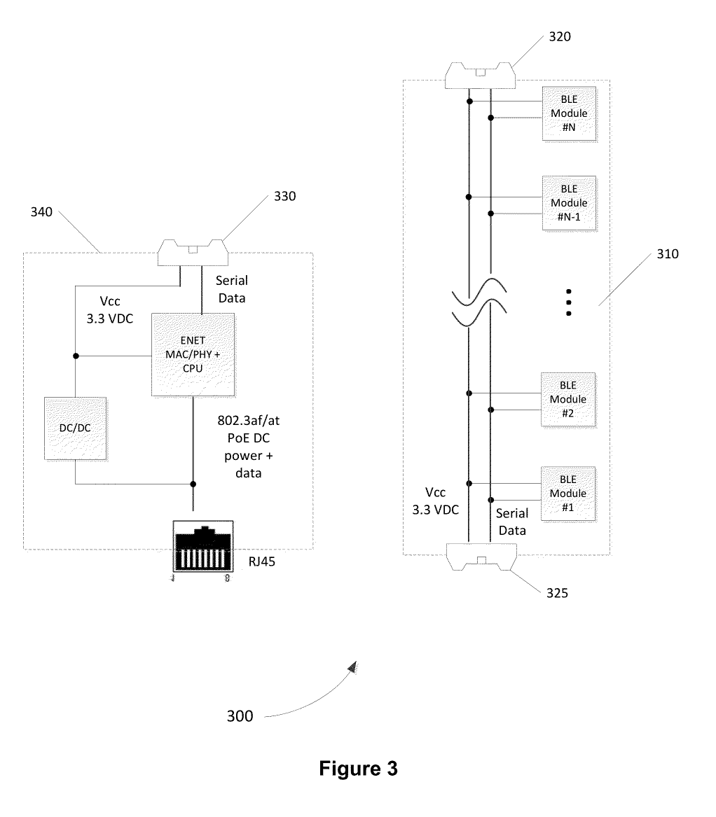

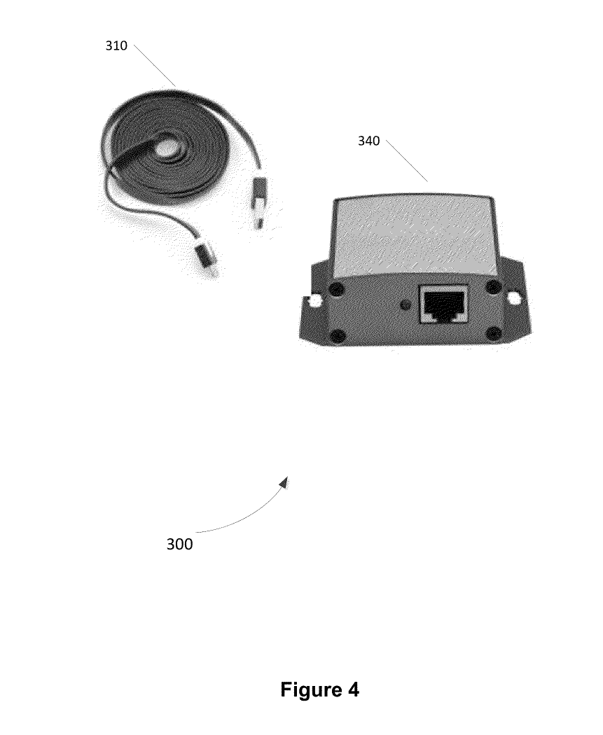

The PCM 120 and CU 110 can be integrated together into one physical structure as shown in FIGS. 1 and 2, or separated into two physically distinct modules or products, as shown in FIGS. 3 and 4. In the latter case, the power and serial data interfaces between the PCM 340 and CU 310 can be connected together via special connectors 325 and 330. The connector approach allows different variations of the PCM to be paired with the CU, and/or for multiple CUs to be connected together in series off of one PCM.

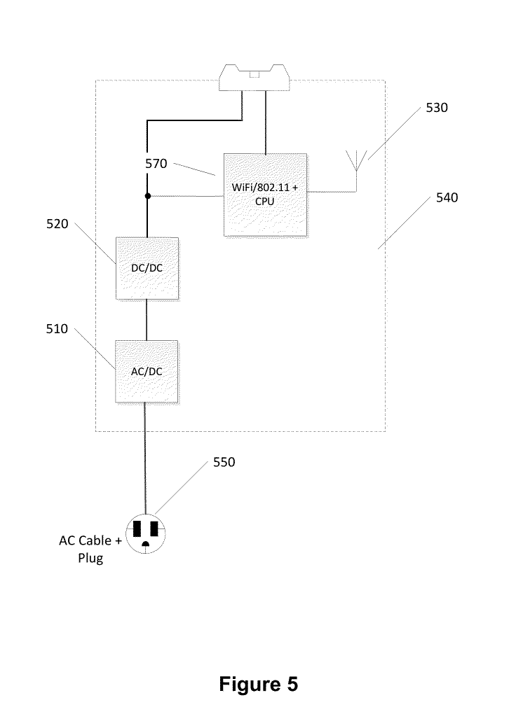

One useful alternative to the PCM 340 shown in FIGS. 3 and 4 is shown in FIG. 5. Instead of using an IEEE 802.3af/at PoE interface for DC power and data, the embodiment shown in FIG. 5 includes a PCM 540 powered by a 110/220 VAC outlet 550 and uses an internal 802.11/Wi-Fi radio 570 instead of an IEEE 802.3 wired Ethernet for network communication. The AC/DC converter 510 converts the AC power from outline 550 to DC, and the DC/DC converter 520 converts that DC voltage to the desired voltage level for use by the 802.11/Wi-Fi radio 570. An antenna 530 is connected to the 802.11/Wi-Fi radio 570.

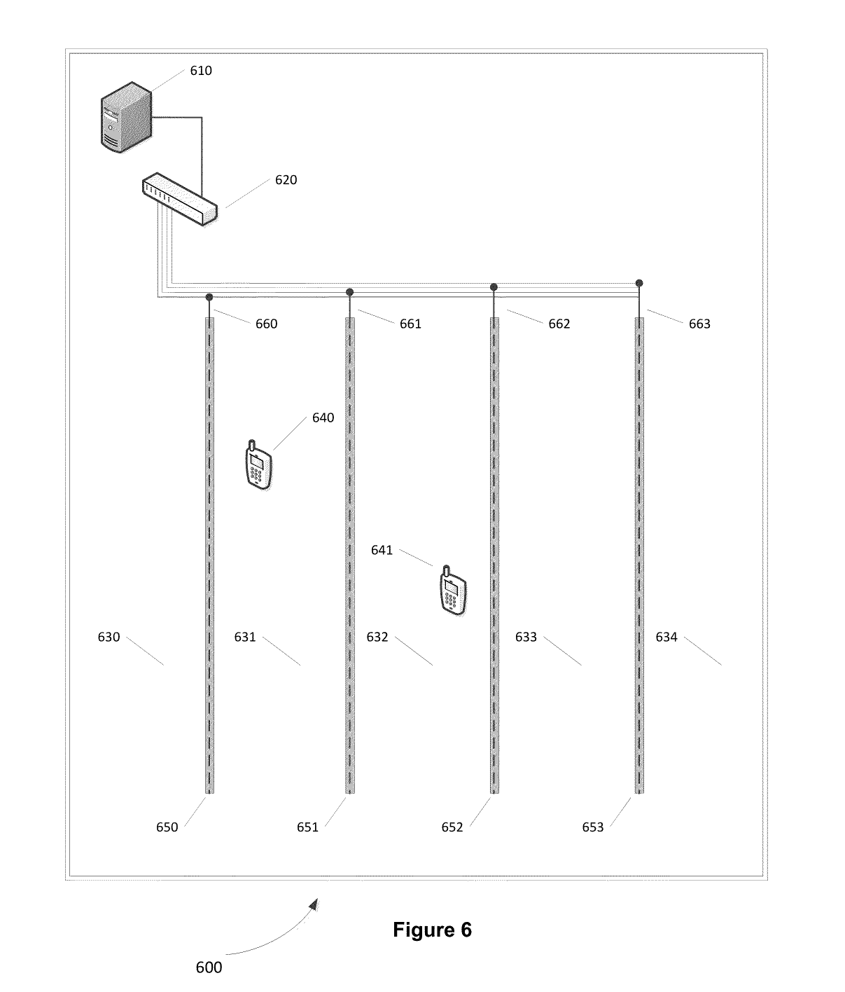

FIG. 6 shows an example of a cable assembly-based positioning system deployed in a retail store or other environment in accordance with various embodiments. The retail store in this example has five aisles 630-634 separated by four long shelves 650-653 on which retail products are displayed to visiting customers. The cable assembly system 600 includes a server CPU 610, a network switch 620 with IEEE 802.3af/at power-over-Ethernet (PoE) powered LAN interfaces, one or more mobile devices 640 and 641 that support the Bluetooth Low Energy (BLE) wireless protocol, and one or more PoE-powered cable assemblies 660-663 (of the types described herein in connection with FIGS. 1-5 and 9) attached to the switch 620 that run along each of the shelves. The cable assemblies can be deployed by running them underneath, inside, alongside or on top of the shelving units, under the flooring tile along the center of each aisle, or in the light conduits above each aisle.

The mobile devices 640 and 641 are typically battery-powered mobile wireless user devices such as smartphones or table computer device that contain a BLE chipset as well as 802.11/Wi-Fi and cellular chipsets.

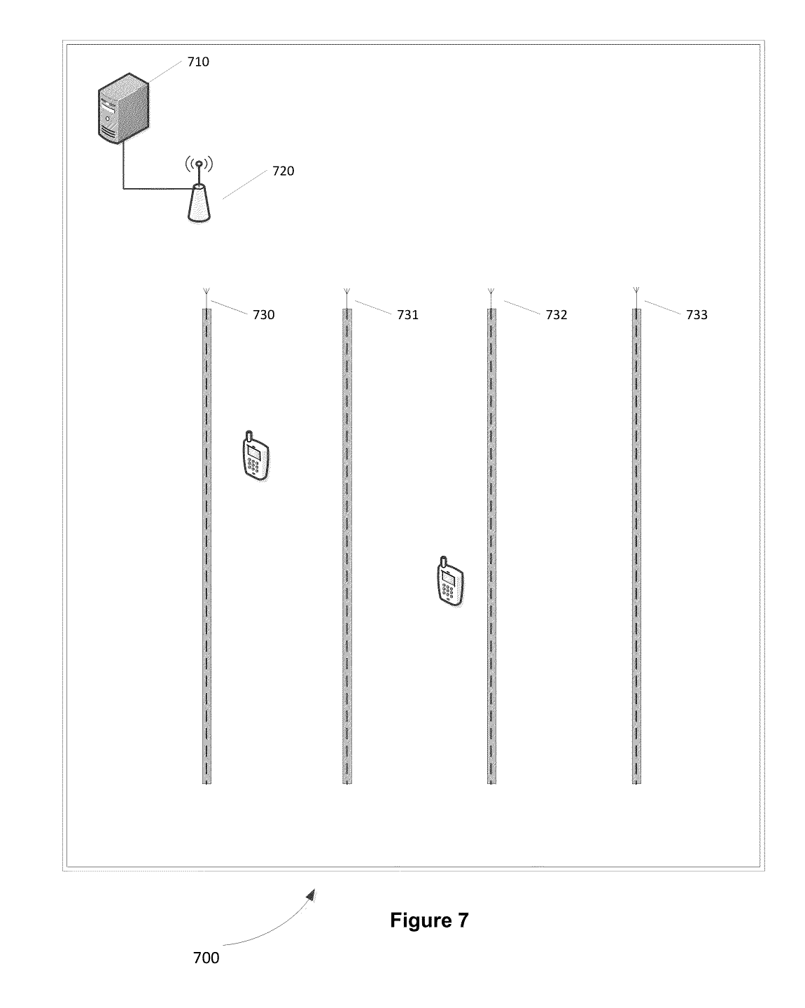

FIG. 7 shows how the example retail store application 600 of FIG. 6 would be modified if an AC-powered cable assembly implementation is used. In this case the cable assemblies 730-733 would use AC-powered PCMs like the that shown in FIG. 5 for power, and would communicate with the network using their integrated Wi-Fi radios 570 through a Wi-Fi Access Point 720, and ultimately to server 710.

Referring again to FIG. 1 (with continued reference to FIGS. 6 and 7), the CPU 170 and BLE modules 130-133 use a master/subordinate relationship to exchange messages and data over their serial data bus lines 150, with the CPU 170 being the master and the BLE modules 130-133 being the subordinates. The CPU 170 and server 610 (FIG. 6) exchange messages and data through either the local Wi-Fi network or wired Ethernet network. Depending on the application, the mobile device communicates with the server 610 either directly through the local Wi-Fi network, or indirectly from the Internet via the mobile user device's cellular radio.

The BLE modules 130-133 can be configured as either BLE emitters or sensors. In emitter mode, the BLE modules transmit BLE advertisements periodically at some interval specified by the CPU 170 of PCM 120. The mobile reports the UUID and received signal strength (RSS) of the closest (i.e., having max RSS) emitter to the server, and the server reports back the location coordinates of that emitter. An improved location estimate can be obtained if instead of reporting the RSS of the closest emitter, the mobile device reports the UUID and RSS for all “detectable” BLE emitters (i.e., above the mobile device's receive noise floor). This will allow the server to triangulate on the mobile device's position using the relative positions and received signal strengths from the multiple BLE emitters. The mapping of the UUID and RSSs to the location can also be performed on the mobile device instead of the server provided that it is equipped with a table containing the physical location and UUID of each emitter.

In a sensor mode, the BLE modules are configured to continually scan their receivers, looking for BLE advertisements sent from the mobile device. When a sensor hears an advertisement, it passes the mobile UUID and RSS of the received advertisement to the location server through the CPU and MAC/PHY 170 of the PCM 120. The server can then estimate the location of the mobile (using either triangulation or a nearest-sensor approach) and periodically pass the location information back to the mobile device by sending it a message over the local Wi-Fi or cellular internet network.

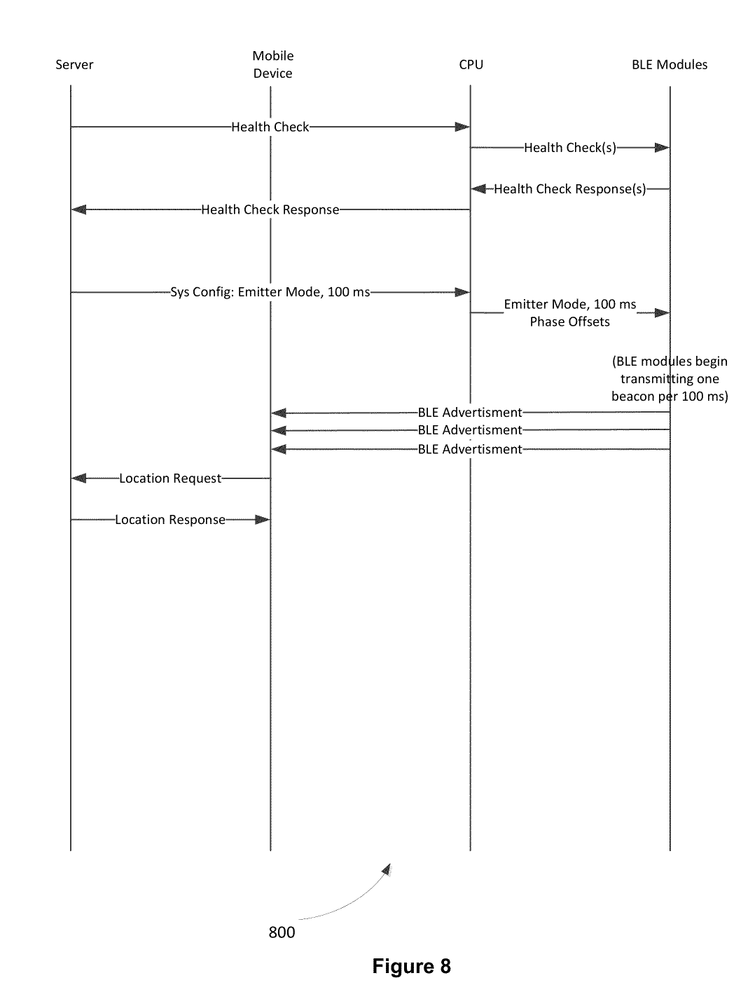

FIG. 8 shows a typical message exchange 800 among the system components. In this example the server asks a cable assembly to report back its health status, and then directs it to start an emitter-mode session. The health check sequence begins when the server sends a health check message to the cable assembly which is received by the CPU in the PCM, which in turn sends out a sequence of health check messages to each of the BLE modules. The BLE modules each return their status in a health check response message to the CPU. The CPU then aggregates the responses into one health check response message for the entire cable assembly and sends it back to the server.

After receiving the health check response from the CPU, the server sends back a message directing it to put the BLE modules into emitter mode, transmitting beacons once per 100 ms, for example. The CPU directs each of the modules to begin an emitter mode session using a 100 ms beacon interval, and the modules begin transmitting the beacons. The mobile device detects one or more of the beacons, and sends a Location Request message to the server containing the UUID and RSS for each of its received beacons. The server then responds with Location Response message containing the estimated position of the mobile device.

As described above, each cable assembly has tight control over transmission made by each of its BLE modules. Since each cable assembly can communicate on the store's network via a LAN or Wi-Fi connection, it is possible to time synchronize all of the cable assemblies (as well as all of the BLE modules on all of the cable assemblies) in the store to a common timebase in order to minimize interference. For example, the cable assemblies could use the Network Time Protocol (NTP) to synchronize their clocks to one global time base, and use time-division multiple access (TDMA) to arbitrate their transmissions so as to minimize the likelihood that any two cable assemblies that are in close physical proximity to one another transmit their BLE advertisements (or any other BLE information) at the same time and on the same frequency.

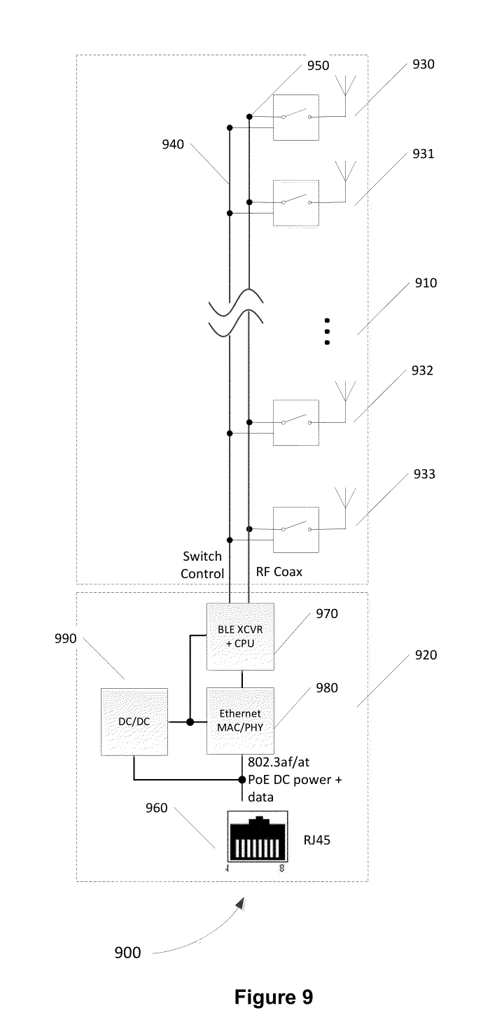

An alternative to the cable assembly design of FIG. 1 involves the use of only one BLE transceiver instead of multiple BLE transceivers to source N RF switch/antenna modules spaced along the cable where the BLE modules used to be. This approach is shown in FIG. 9, in which the CU 910 connects to the PCM 920. In the PCM 920 there would likely be one chipset 970 for the BLE transceiver and CPU and another chipset 980 for the Ethernet MAC/PHY with the IEEE 802.3af/at power extraction circuitry implemented external to both, and connected to jack 960. The RF output from the BLE transceiver would be run inside the cable through a stretch of RF coax 950 with breakouts along the way to each of the RF switch/antenna assemblies 930-933 that are connected to digital data lines 940 and power lines 950. The one or more digital data lines 940 would be used to turn on and off each of the switches from the CPU 970. This approach operates similar to a distributed antenna system (DAS), but implemented inside of a cable assembly.

In summary, in accordance with one embodiment, a cable assembly is provide that includes a cable; one or more radio transceivers spaced along the length of the cable; and a first set of one or more conductors within the cable to supply DC power and ground to the one or more radio transceivers. The cable assembly may further include a second set of one or more conductors within the cable to carry communication and control signals to the one or more radio transceivers.

In one form, the cable assembly may include a first connector at one end of the cable, the first connector configured to connect to an external device from which the DC power, ground, the communication signals and control signals are supplied to the one or more radio transceivers via the first and second sets of one or more conductors. Moreover, a second connector may be provided at the other end of the cable, the second connector configured to provide DC power, ground, communications and control signals to the radio transceivers on another cable assembly.

The external device (e.g., power conditioning module) includes: a control processor that supplies the control signals to the one or more radio transceivers via the second set of one or more conductors, a network interface port, a network media access control/physical layer MAC/PHY processor that carries local area network (LAN) data between the control processor and a LAN via the network interface port, and a power converter circuit that obtains DC power and ground signals from the network interface port for supply to the one or more radio transceivers via the first set of one or more conductors. The control processor, network interface port, network MAC/PHY processor and power converter circuit are contained within a housing that is connected to the cable.

In one form, the cable assembly further includes: a control processor that supplies the control signals to the one or more radio transceivers via the second set of one or more conductors, a network interface port, a network media access control/physical layer MAC/PHY processor that carries local area network (LAN) data between the control processor and a LAN via the network interface port, and a power converter circuit that obtains DC power and ground signals from the network interface port for supply to the one or more radio transceivers via the first set of one or more conductors.

In another form, the cable assembly further includes: a control processor that supplies the control signals to the one or more radio transceivers via the second set of one or more integrated conductors, an AC power cable and plug, a wireless local area network (WLAN) transceiver, a WLAN MAC/PHY processor that carries local area network (LAN) data between the control processor and a LAN via the WLAN transceiver, and an AC-to-DC converter that converts AC power from the AC power cable to DC power and supplies the DC power and ground to the one or more radio transceivers via the first set of one or more integrated conductors.

In accordance with another embodiment, a cable assembly is provided that comprises: a cable; a radio transceiver; a control processor; a plurality of switched antennas spaced along the length of the cable; one or more integrated conductors within the cable that connect the control processor to a control port on each of the plurality of switched antennas, and one or more integrated transmission lines within the cable that connect the radio transceiver to each of the switched antennas. The control processor configures the plurality of switched antennas so that the radio transceiver is connected to only one of the plurality of switched RF antennas at a time. The radio transceiver may be a Bluetooth Low Energy transceiver that transmits using a different universally unique identifier (UUID) depending to which of the plurality of switched antennas the radio transceiver is connected, and the control processor and radio transceiver may be contained within a housing that is connected to the cable.

In accordance with another embodiment, a system is provided comprising: a plurality of cable assemblies, each cable assembly comprising: a cable; one or more radio transceivers spaced along the length of the cable; and a first set of one or more conductors within the cable to supply DC power and ground to the one or more radio transceivers; at least one network switch connected to the plurality of cable assemblies, wherein the network switch enables network connectivity to the one or more radio transceivers of each cable assembly; and a server configured to be in network communication with the plurality of cable assemblies and to track locations of one or more mobile wireless user devices with respect to respective radio transceivers in each of the plurality of cable assemblies.

Each of the radio transceivers in the system emits a wireless signal that includes an identifier, and wherein a mobile wireless user device detects the wireless signal from one or more radio transceivers, obtains the identifier contained in the detected wireless signal, and sends to the server a report the identifier and received signal strength of the wireless signal detected from one or more radio transceivers. Each of the radio transceivers in each cable assembly is a Bluetooth Low Energy transceiver. The server computes a location of the mobile wireless user device based on the report. The server may send to each of the radio transceivers a message directing each radio transceiver to operate in an emitter mode such that each radio transceiver emits a beacon on a periodic basis.

The above description is intended by way of example only. Various modifications and structural changes may be made therein without departing from the scope of the concepts described herein and within the scope and range of equivalents of the claims.

What is claimed is:

1. A cable assembly, comprising
a cable;
one or more radio transceivers spaced along the length of the cable; and
a first set of one or more conductors within the cable to supply DC power and ground to the one or more radio transceivers.

2. The cable assembly of claim 1, further comprising a second set of one or more conductors within the cable to carry communication and control signals to the one or more radio transceivers.

3. The cable assembly of claim 2, further comprising a first connector at one end of the cable, the first connector configured to connect to an external device from which the DC power, ground, the communication signals and control signals are supplied to the one or more radio transceivers via the first and second sets of one or more conductors.

4. The cable assembly of claim 3, further comprising a second connector at the other end of the cable, the second connector configured to provide DC power, ground, communications and control signals to the radio transceivers on another cable assembly.

5. The cable assembly of claim 3, wherein the external device includes:
a control processor that supplies the control signals to the one or more radio transceivers via the second set of one or more conductors,
a network interface port,
a network media access control/physical layer MAC/PHY processor that carries local area network (LAN) data between the control processor and a LAN via the network interface port, and
a power converter circuit that obtains DC power and ground signals from the network interface port for supply to the one or more radio transceivers via the first set of one or more conductors.

6. The cable assembly of claim 5, wherein the control processor, network interface port, network MAC/PHY processor and power converter circuit are contained within a housing that is connected to the cable.

7. The cable assembly of claim 2, further comprising:
a control processor that supplies the control signals to the one or more radio transceivers via the second set of one or more conductors,
a network interface port,
a network media access control/physical layer MAC/PHY processor that carries local area network (LAN) data between the control processor and a LAN via the network interface port, and
a power converter circuit that obtains DC power and ground signals from the network interface port for supply to the one or more radio transceivers via the first set of one or more conductors.

8. The cable assembly of claim 7, wherein the control processor, network interface port, network MAC/PHY processor and power converter circuit are contained within a housing that is connected to the cable.

9. The cable assembly of claim 2, further comprising:
a control processor that supplies the control signals to the one or more radio transceivers via the second set of one or more integrated conductors,
an AC power cable and plug,
a wireless local area network (WLAN) transceiver,
a WLAN MAC/PHY processor that carries local area network (LAN) data between the control processor and a LAN via the WLAN transceiver, and
an AC-to-DC converter that converts AC power from the AC power cable to DC power and supplies the DC power and ground to the one or more radio transceivers via the first set of one or more integrated conductors.

10. The cable assembly of claim 9, wherein the control processor, WLAN transceiver, WLAN MAC/PHY processor and AC-to-DC converter are contained within a housing that is connected to the cable.

11. A cable assembly, comprising
a cable;
a radio transceiver;
a control processor;
a plurality of switched antennas spaced along the length of the cable;
one or more integrated conductors within the cable that connect the control processor to a control port on each of the plurality of switched antennas, and
one or more integrated transmission lines within the cable that connect the radio transceiver to each of the switched antennas.

12. The cable assembly of claim 11, wherein the control processor configures the plurality of switched antennas so that the radio transceiver is connected to only one of the plurality of switched RF antennas at a time.

13. The cable assembly of claim 12, wherein the radio transceiver is a Bluetooth Low Energy transceiver that transmits using a different universally unique identifier (UUID) depending to which of the plurality of switched antennas the radio transceiver is connected.

14. The cable assembly of claim 11, wherein the control processor and radio transceiver are contained within a housing that is connected to the cable.

15. A system comprising:
a plurality of cable assemblies, each cable assembly comprising:
a cable;
one or more radio transceivers spaced along the length of the cable; and
a first set of one or more conductors within the cable to supply DC power and ground to the one or more radio transceivers;
at least one network switch connected to the plurality of cable assemblies, wherein the network switch enables network connectivity to the one or more radio transceivers of each cable assembly;
a server configured to be in network communication with the plurality of cable assemblies and to track locations of one or more mobile wireless user devices with respect to respective radio transceivers in each of the plurality of cable assemblies.

16. The system of claim 15, wherein each of the radio transceivers emits a wireless signal that includes an identifier, and wherein a mobile wireless user device detects the wireless signal from one or more radio transceivers, obtains the identifier contained in the detected wireless signal, and sends to the server a report the identifier and received signal strength of the wireless signal detected from one or more radio transceivers.

17. The system of claim 16, wherein the server computes a location of the mobile wireless user device based on the report.

18. The system of claim 17, wherein the server sends to each of the radio transceivers a message directing each radio transceiver to operate in an emitter mode such that each radio transceiver emits a beacon on a periodic basis.

19. The system of claim 15, wherein each of the radio transceivers in each cable assembly is a Bluetooth Low Energy transceiver.

20. The system of claim 15, wherein each cable assembly further includes:
a control processor that supplies the control signals to the one or more radio transceivers,
a network interface port,
a network media access control/physical layer MAC/PHY processor that carries local area network (LAN) data between the control processor and a LAN via the network interface port, and
a power converter circuit that obtains DC power and ground signals from the network interface port for supply to the one or more radio transceivers.
